(19) United States
(12) Patent Application Publication
(10) Pub. No.: US 2007/0000523 A1
(43) Pub. Date: Jan. 4, 2007

(54) Cleaning composition and related methods

(76) Inventors: Se-Yeon Kim, Seoul (KR); Pil-Kwon Jun, Yongin-si (KR); Jung-Dae Park, Seoul (KR); Myoung-Ok Han, Suwon-si (KR); Jea-Wook Kim, Seoul (KR); Seung-Ki Chae, Seoul (KR); Kook-Joo Kim, Seoul (KR); Jae-Seok Lee, Hwaseong-si (KR); Yong-Kyun Ko, Osan-si (KR); Kwang-Shin Lim, Yongin-si (KR); Yang-Koo Lee, Gwancheon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/454,829

(22) Filed: Jun. 19, 2006

(30) Foreign Application Priority Data
Jul. 4, 2005 (KR) 2005-0059768

(51) Int. Cl. B08B 3/04

(52) U.S. Cl. 134/25.4; 134/26; 134/27

(57) ABSTRACT

A cleaning composition is disclosed. The cleaning composition comprises about 80 to 99.8999 percent by weight of an ammonium fluoride aqueous solution, about 0.1 to 5 percent by weight of a buffering agent, and about 0.0001 to 15 percent by weight of a corrosion-inhibiting agent. A method of preparing the cleaning composition, a method of cleaning a substrate using the cleaning composition, and a method of manufacturing a semiconductor device using the cleaning composition are also disclosed.

### BACKGROUND OF THE INVENTION

1. Field of the Invention

Exemplary embodiments of the present invention relate to a cleaning composition and related methods. In particular, exemplary embodiments of the invention relate to a cleaning composition and a method of preparing the cleaning composition, a method of cleaning a substrate, and a method of manufacturing a semiconductor device using the cleaning composition.

This application claims priority to Korean Patent Application No. 2005-59768, filed on Jul. 4, 2005, the subject matter of which is hereby incorporated by reference in its entirety.

2. Description of the Related Art

Along with the development of information processing apparatuses, a desire for semiconductor devices having high degrees of integration and rapid response speeds has arisen. Hence, the technology for manufacturing semiconductor devices has been developed to improve the integration degree, reliability, and response speed of the semiconductor devices produced. In order to improve the response speed of semiconductor devices, conductive structures in the semiconductor devices have been formed using a material having a relatively low resistance. For example, a metal pattern in a conductive structure such as a gate electrode, a bit line, and/or a wiring has been formed using a metal such as tungsten, aluminum, etc., instead of tungsten silicide.

A dry etching process for partially removing a conductive layer, along with an ashing process and/or a stripping process for removing a photoresist pattern are performed to form a conductive structure such as a bit line, a gate electrode, a wiring, etc. When the conductive structure is formed on a substrate through dry etching, ashing, and/or stripping processes, polymer remains on the conductive structure and/or the substrate. Examples of the polymer are etching residues, organic polymer, oxide polymer, and metallic polymer and combinations of same. The polymer that remains on the conductive structure raises the electrical resistance of the semiconductor device comprising the conductive structure and generates an electrical short between adjacent wirings. Therefore, to enhance the reliability of the semiconductor device, a cleaning composition capable of sufficiently removing the polymer from the conductive structure and/or the substrate is required.

Conventional cleaning solutions such as APM (standard cleaning solution, SC-1) or SPM (sulfuric acid stripper) corrode metal (e.g., tungsten) in a cleaning process for removing the polymer. Thus, conventional cleaning solutions cannot be used to clean a substrate on which a metal wiring is exposed.

Substrates on which metal wiring is exposed are generally cleaned using an organic stripper comprising an organic solvent. The organic stripper does not severely corrode the metal wiring formed on the substrate; however, the organic stripper does not sufficiently remove the polymer from the metal wiring and/or the substrate. Particularly, the organic stripper does not etch an oxide, so the organic stripper does not remove the oxide polymer, generated in the dry etching process, from the metal wiring and/or the substrate. Furthermore, a cleaning process using the organic stripper requires a relatively high cleaning temperature of about 65° C. to 85° C.

Additionally, as patterns in semiconductor devices become finer, a cleaning composition capable of preventing a conductive pattern from being contaminated by particles and/or metallic impurities is required. In the cleaning process, the polymer, such as organic polymer, oxide polymer, metallic polymer, etc., is dispersed in the cleaning composition and forms suspended particles. The metallic polymer is also partially dissolved in the cleaning composition, and subsequently exists in the cleaning composition as metal ions. Additionally, as the number of wafers cleaned using the cleaning composition and the process time for the cleaning process increase, the amounts of the particles and the metal ions in the cleaning composition also increase. The particles and the metal ions are then adsorbed onto the wafer again and thus contaminate the wafer, which reduces the productivity of a semiconductor manufacturing process and the reliability of a semiconductor device produced through that process.

To overcome the problems of the conventional organic stripper, as described above, cleaning solutions capable of removing the polymer and the particles without damaging the conductive structure have been developed. For example, a first cleaning solution and a method of cleaning a copper wiring using the first cleaning solution are disclosed in Korean Laid-Open Patent Publication No. 2004-74611. The first cleaning solution comprises an oxidizing agent (e.g., nitric acid or hydrogen peroxide), an inorganic acid (e.g., sulfuric acid), an organic acid (e.g., acetic acid), a fluorine compound, a corrosion-inhibiting agent, and greater than about 80 percent by weight of water. The first cleaning solution also has a pH of about 3 to 10. Japanese Laid-Open Patent Publication No. 1998-55993 discloses a second cleaning solution comprising a quaternary ammonium salt, a fluorine compound, a water-miscible organic solvent, and an aqueous solution comprising an inorganic acid and/or an organic acid. A third cleaning solution that comprises hydroxylamine, a fluorine compound, and water is disclosed in U.S. Pat. No. 6,191,086. The third cleaning solution has a pH of about 2 to 9. A first composition removing an etching residue is disclosed in Korean Laid-Open Patent Publication No. 2005-25316. The first composition comprises a dicarboxylic acid, a base combining with the dicarboxylic acid to form a buffer, a source of fluoride ion, a water-miscible organic solvent, and water.

However, the cleaning solutions and the first composition described above do not effectively remove the polymer from a substrate on which the conductive structure (e.g., a metal wiring) is exposed, and do not prevent damage to the conductive structure. Furthermore, the above cleaning solutions and the first composition have some limitations in their respective abilities to prevent suspended particles and metallic impurities from being readsorbed onto the conductive structure and/or the substrate.

### SUMMARY OF THE INVENTION

Exemplary embodiments of the present invention provide a cleaning composition able to remove polymer with a reduced amount of damage to a conductive structure relative to a conventional cleaning composition and a reduced amount of contamination of the conductive structure by particles and/or metallic impurities relative to a conventional cleaning composition. Exemplary embodiments of the present invention also provide a method of preparing the cleaning composition, a method of cleaning a substrate using the cleaning composition, and a method of manufacturing a semiconductor device using the cleaning composition.

In one embodiment, the invention provides cleaning composition comprising about 80 to 99.8999 percent by weight of an ammonium fluoride aqueous solution, about 0.1 to 5 percent by weight of a buffering agent, and about 0.0001 to 15 percent by weight of a corrosion-inhibiting agent.

In another embodiment, the invention provides a cleaning composition comprising about 0.1 to about 5 percent by weight of an alkylammonium hydroxide, about 0.01 to 2 percent by weight of a fluorine-containing compound, about 0.1 to 5 percent by weight of a buffering agent, at least one corrosion-inhibiting agent, and pure water.

In yet another embodiment, the invention provides a method of preparing a cleaning composition comprising mixing about 0.1 to 5 percent by weight of an alkylammonium hydroxide, about 0.01 to 2 percent by weight of a fluorine-containing compound, and about 73 to 99.7899 percent by weight of pure water to prepare an ammonium fluoride aqueous solution. The method further comprises adding about 0.1 to 5 percent by weight of a buffering agent and about 0.0001 to 15 percent by weight of a corrosion-inhibiting agent to about 80 to 99.8999 percent by weight of the ammonium fluoride aqueous solution.

In still another embodiment, the invention provides a method of cleaning a substrate comprising preparing a cleaning composition comprising about 80 to 99.8999 percent by weight of an ammonium fluoride aqueous solution, about 0.1 to 5 percent by weight of a buffering agent, and about 0.0001 to 15 percent by weight of a corrosion-inhibiting agent. The method further comprises applying the cleaning composition to the substrate to remove polymer from the substrate, wherein a conductive structure is formed on the substrate and polymer is formed on the substrate, and to form a corrosion-inhibition layer on the conductive structure.

In still another embodiment, the invention provides a method of manufacturing a semiconductor device that comprises forming a conductive structure on a substrate; and cleaning the substrate using a cleaning composition comprising about 80 to 99.8999 percent by weight of an ammonium fluoride aqueous solution, about 0.1 to 5 percent by weight of a buffering agent, and about 0.0001 to 15 percent by weight of a corrosion-inhibiting agent.

### BRIEF DESCRIPTION OF THE DRAWINGS

Exemplary embodiments of the invention will be described herein with reference to the accompanying drawings, in which like reference symbols refer to like or similar elements. In the drawings:

FIG. 1 is a flow chart illustrating a method of cleaning a substrate on which a conductive structure is formed using a cleaning composition in accordance with an exemplary embodiment of the present invention;

FIGS. 2 through 5 are cross-sectional views illustrating a method of forming a word line in a semiconductor device using a cleaning composition in accordance with an exemplary embodiment of the present invention;

FIGS. 6 through 13 are cross-sectional views illustrating a method of forming a bit line in a semiconductor device using a cleaning composition in accordance with an exemplary embodiment of the present invention;

FIG. 14 is a picture of a surface of a silicon wafer cleaned using a cleaning composition prepared in Comparative Example 3;

FIG. 15 is a picture of a surface of a silicon wafer cleaned using a cleaning composition prepared in Example 1;

FIGS. 16 through 18 are SEM pictures of aluminum layer patterns cleaned using cleaning compositions prepared in Comparative Example 1, Example 2, and Example 4, respectively;

FIGS. 19 through 22 are SEM pictures of tungsten layer patterns cleaned using cleaning compositions prepared in Examples 2, 4, 6, and 7, respectively; and,

FIG. 23 is a graph showing the amounts of each type of metal ion remaining on silicon wafers, wherein each silicon wafer was cleaned using a cleaning composition prepared in Example 1, Example 2, Example 5, or Comparative Example 6.

### DESCRIPTION OF THE EXEMPLARY EMBODIMENTS

In the drawings, the sizes and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, third etc., may be used herein to describe various elements, components, regions, layers, and/or sections, these elements, components, regions, layers, and/or sections are not limited by these terms. These terms are only used to distinguish one element, component, region, layer, or section from another element, component, region, layer, or section. Thus, a first element, component, region, layer, or section discussed below could be referred to as a second element, component, region, layer, or section without departing from the scope of the invention as claimed in the accompanying claims.

Spatially relative terms, such as “beneath”, “below”, “lower”, “above”, “upper” and the like, may be used herein for ease of description to describe one element or feature's relationship to other element(s) or feature(s) as illustrated in the drawings. It will be understood that the spatially relative terms are intended to encompass different orientations of the device in use or operation in addition to the orientation depicted in the figures. For example, if the device in the drawings is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments of the invention are described herein with reference to cross-sectional illustrations that are schematic illustrations of idealized embodiments (and intermediate structures) of the invention. As such, variations from the shapes of the illustrations as a result of, for example, manufacturing techniques and/or tolerances, are to be expected. Thus, embodiments of the invention should not be construed as limited to the particular shapes of regions illustrated herein but encompass deviations in shapes that result, for example, from manufacturing. For example, an implanted region illustrated as a rectangle will, typically, have rounded or curved features and/or a gradient of implantation concentration at its edges rather than a binary change from an implanted to a non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

As used herein, the term “percent by weight” means the percentage of the total weight of the cleaning composition. Thus, when a composition is said to comprise 1 percent by weight of a component “A,” the composition comprises a quantity “A” having a weight that is equal to 1 percent of the total weight of the composition.

### Exemplary Cleaning Composition

After a conductive structure is formed on a substrate through dry etching a metal layer and/or an oxide layer, polymer may remain on the conductive structure and/or the substrate. A cleaning composition, in accordance with exemplary embodiments of the present invention, is used to remove the polymer from the substrate with a reduced amount of damage to the conductive structure and a reduced amount of contamination of the conductive structure by particles and/or metallic impurities. Various characteristics of the cleaning composition, in accordance with exemplary embodiments of the present invention, will now be described.

The cleaning composition may reduce the amount of damage caused to the conductive structure during a constituent cleaning process relative to the conventional cleaning composition. The conductive structure may comprise a conductive material such as metal, metal nitride, or doped polysilicon. The cleaning composition comprises an ammonium fluoride aqueous solution, which may normally corrode the conductive structure. Nonetheless, the cleaning composition, in accordance with exemplary embodiments of the present invention, may reduce the corrosion of the conductive structure.

The cleaning composition may also effectively remove polymer from the substrate. Examples of the polymer are etching residues, an organic polymer, an oxide polymer, a metallic polymer, etc. Conventional cleaning compositions do not completely remove the polymer. However, the cleaning composition in accordance with exemplary embodiments of the present invention may readily remove the polymer from the substrate.

Additionally, the cleaning composition may reduce the amount that the conductive structure and/or the substrate is contaminated by particles. During the cleaning process, polymer is dispersed in the cleaning composition to form suspended particles. A suspended particle may be adsorbed onto the conductive structure and/or the substrate again, thereby generating particle contamination, which is a kind of inverse contamination. As patterns in a semiconductor device become finer, the productivity of a manufacturing process and reliability of the semiconductor device may be greatly affected by particle contamination. The cleaning composition in accordance with exemplary embodiments of the present invention may reduce particle contamination and may more effectively remove readsorbed particles.

The cleaning composition may also reduce the amount that the conductive structure and/or the substrate are contaminated by metallic impurities. The metallic portion of the polymer is partially dissolved in the cleaning composition and exists as metal ions in the cleaning composition. The metallic impurities, such as metallic polymer, metal ions, etc., may be adsorbed onto the conductive structure again, thereby generating metal contamination. The metal contamination may also greatly reduce the productivity of the manufacturing process and the reliability of the semiconductor devices produced. However, the cleaning composition in accordance with exemplary embodiments of the present invention may reduce the amount of metal contamination on the substrate and/or the conductive structure.

In accordance with one exemplary embodiment of the present invention, the cleaning composition comprises about 80 to 99.8999 percent by weight of an ammonium fluoride aqueous solution, about 0.1 to 5 percent by weight of a buffering agent, and about 0.0001 to 15 percent by weight of a corrosion-inhibiting agent. In addition, the cleaning composition has the characteristics described above.

In accordance with an exemplary embodiment of the present invention, the ammonium fluoride aqueous solution may be adapted to remove polymer that remains on the conductive structure and prevent particle contamination. In an exemplary embodiment of the present invention, the ammonium fluoride aqueous solution comprises alkylammonium hydroxide, a fluorine-containing compound, and pure water. The alkylammonium hydroxide may be adapted to remove polymer such as organic polymer, oxide polymer, and/or metallic polymer. Additionally, the fluorine-containing compound may be adapted to contribute to the removal of oxide polymer. Furthermore, the ammonium fluoride aqueous solution may be adapted to electrically charge surfaces of particles suspended in the cleaning composition to prevent the particles from being readsorbed, and may be adapted to remove readsorbed particles from the conductive structure.

When the cleaning composition comprises less than about 80 percent by weight of the ammonium fluoride aqueous solution, the cleaning composition's ability to remove polymer and its ability to remove particles may be reduced. In addition, when the cleaning composition comprises more than about 99.8999 percent by weight of the ammonium fluoride aqueous solution, the cleaning composition may corrode a conductive pattern in the conductive structure and may damage an oxide pattern in the conductive structure. Also, particle contamination may not be readily prevented when the cleaning composition comprises more than about 99.8999 percent by weight of the ammonium fluoride aqueous solution. Thus, the cleaning composition, in accordance with one exemplary embodiment of the present invention, comprises about 80 to 99.8999 percent by weight of the ammonium fluoride aqueous solution, and preferably about 93 to 99.4995 percent by weight of the ammonium fluoride aqueous solution.

The ammonium fluoride aqueous solution, in accordance with one exemplary embodiment of the present invention, comprises about 0.1 to 5 percent by weight of an alkylammonium hydroxide, about 0.01 to 2 percent by weight of a fluorine-containing compound, and a remainder of pure water.

When the ammonium fluoride aqueous solution comprises less than about 0.1 percent by weight of the alkylammonium hydroxide, the cleaning composition's ability to remove polymer and its ability to remove particles may be reduced (i.e., reduced relative to when the ammonium fluoride aqueous solution comprises about 0.1 percent by weight or more of the alkylammonium hydroxide). In addition, when the ammonium fluoride aqueous solution comprises more than about 5 percent by weight of alkylammonium hydroxide, the cleaning composition may corrode the conductive structure when the conductive structure comprises metal (e.g., aluminum). Thus, the cleaning composition, in accordance with one exemplary embodiment of the present invention, comprises about 0.1 to 5 percent by weight of the alkylammonium hydroxide, and preferably about 0.2 to 3 percent by weight of the alkylammonium hydroxide.

The alkylammonium hydroxide may comprise, for example, at least one of tetramethylammonium hydroxide, tetraethylammonium hydroxide, tetrapropylammonium hydroxide, tetrabutylammonium hydroxide, tetrahexylammonium hydroxide, tetraoctylammonium hydroxide, benzyltriethylammonium hydroxide, diethyldimethylammonium hydroxide, hexadecyltrimethylammonium hydroxide, methyltributylammonium hydroxide, etc.

When the cleaning composition comprises less than about 0.01 percent by weight of the fluorine-containing compound, the cleaning composition's ability to remove the oxide polymer and the particles may be poor. In addition, when the cleaning composition comprises more than about 2 percent by weight of the fluorine-containing compound, the cleaning composition may damage an oxide layer. Thus, the cleaning composition, in accordance with an exemplary embodiment of the present invention comprises about 0.01 to 2 percent by weight of the fluorine-containing compound, and preferably about 0.05 to 1 percent by weight of the fluorine-containing compound.

The fluorine-containing compound may comprise, for example, at least one of hydrogen fluoride, ammonium fluoride, tetramethylammonium fluoride, tetraethylammonium fluoride, tetrapropylammonium fluoride, tetrabutylammonium fluoride, fluoroboric acid, tetramethylammonium tetrafluoroborate, tetraethylammonium tetrafluoroborate, tetrapropylammonium tetrafluoroborate, tetrabutylammonium tetrafluoroborate, etc.

The ammonium fluoride aqueous solution, in accordance with an exemplary embodiment of the present invention, also comprises pure water. The pure water may comprise, for example, deionized water, ultra pure water, etc.

As mentioned previously, the cleaning composition, in accordance with one exemplary embodiment of the present invention, comprises a buffering agent. The buffering agent, in accordance with an exemplary embodiment of the present invention, may be adapted to maintain the cleaning composition's ability to remove polymer and reduce particle contamination and metal contamination. When the cleaning composition is reused repeatedly, the pH of the cleaning composition may vary. The buffering agent may stabilize the pH of the cleaning composition to maintain the cleaning composition's ability to remove polymer. Accordingly, the buffering agent in the cleaning composition may enable the cleaning composition to remove polymer well in a relatively wide pH range.

In addition, the buffering agent may be adapted to contribute to preventing the conductive structure and/or the substrate from being contaminated by particles and metallic impurities when the cleaning composition is used. In an exemplary embodiment of the present invention, the buffering agent may be adapted to electrically charge surfaces of the particles to prevent the particles from being readsorbed onto the conductive structure. Considering the zeta potential of the particles, it may be desirable to use a basic cleaning solution to prevent the particles from being readsorbed, but the basic cleaning solution may not effectively remove metallic impurities such as a metallic polymer, a metal ion, etc. Alternatively, an acidic cleaning solution may readily remove the metallic impurities, but may not prevent the particles from being readsorbed. The buffering agent in the cleaning composition may be adapted to properly adjust the zeta potential of the particles in accordance with a variation of the pH to prevent the particles and the metallic impurities from being readsorbed. Therefore, the cleaning solution, in accordance with one exemplary embodiment of the present invention may be able to remove particles well even though the pH of the cleaning composition varies.

When the cleaning composition comprises less than about 0.1 percent by weight of the buffering agent, the cleaning composition's ability to remove the polymer and the particles may not be stable. In addition, the buffering agent may not contribute to the stability of the pH of the cleaning composition when the cleaning composition comprises more than about 5 percent by weight of the buffering agent because that amount of the buffering agent may change the pH of the cleaning composition because of acidity of the buffering agent itself. Thus, the cleaning composition, in accordance with an exemplary embodiment of the present invention, comprises about 0.1 to 5 percent by weight of the buffering agent, and preferably about 0.5 to 3 percent by weight of the buffering agent.

The buffering agent may comprise, for example, inorganic ammonium salt. The inorganic ammonium salt may comprise, for example, at least one of ammonium nitrate, ammonium sulfate, ammonium iodate, etc.

As mentioned previously, the cleaning composition, in accordance with one exemplary embodiment of the present invention, comprises a corrosion-inhibiting agent. In an exemplary embodiment of the present invention, the corrosion-inhibiting agent may be adapted to form a corrosion-inhibition layer on the conductive structure to reduce the amount of damage that the ammonium fluoride aqueous solution causes to the conductive structure. The corrosion-inhibiting agent may be adsorbed onto an exposed portion of the conductive structure, that is, a portion of the conductive structure on which the polymer does not remain. Accordingly, when a substrate comprising the conductive structure is cleaned using the cleaning composition, the corrosion-inhibiting agent may reduce the amount of damage that the ammonium fluoride aqueous solution causes to the conductive structure. Furthermore, the corrosion-inhibiting agent may form an additional corrosion-inhibition layer on a portion of the conductive structure from which the polymer is removed, so the corrosion-inhibiting agent may effectively reduce the amount of damage caused to the conductive structure.

When the cleaning composition comprises less than about 0.0001 percent by weight of the corrosion-inhibiting agent, the cleaning composition may damage the conductive structure. In addition, when the cleaning composition comprises more than about 15 percent by weight of the corrosion-inhibiting agent, the corrosion-inhibiting effect of the cleaning composition may not substantially increase relative to when it comprises less than that amount, and the corrosion-inhibiting agent may remain on the conductive structure to the detriment of the reliability of a semiconductor device comprising the conductive structure. Thus, the cleaning composition, in accordance with an exemplary embodiment of the present invention, comprises about 0.0001 to 15 percent by weight of the corrosion-inhibiting agent, and preferably about 0.0005 to 4 percent by weight of the corrosion-inhibiting agent.

In accordance with an exemplary embodiment of the cleaning composition, the corrosion-inhibiting agent in the cleaning composition comprises at least one of a first corrosion-inhibiting agent and a second corrosion-inhibiting agent. The first corrosion-inhibiting agent may comprise, for example, at least one of an alkanesulfonic acid, a carboxylic acid, an alcohol, etc. The second corrosion-inhibiting agent may comprise, for example, a surfactant.

The first corrosion-inhibiting agent, in accordance with an exemplary embodiment of the present invention, comprises a lone electron pair that may be selected in view of the metal used in the conductive structure, so the first corrosion-inhibiting agent may form a corrosion-inhibition layer on the conductive structure to prevent the conductive structure from being damaged. In addition, the ammonium fluoride aqueous solution of the cleaning composition may have a pH of about 8 to 12, and the corrosion-inhibiting agent may reduce the total pH of the cleaning composition. Thus, the corrosion-inhibiting agent may reduce the amount of corrosion caused to the conductive structure by the ammonium fluoride aqueous solution. Furthermore, the first corrosion-inhibiting agent may contribute to adjusting the zeta potential of the particles to reduce particle contamination.

When the cleaning composition comprises less than about 0.1 percent by weight of the first corrosion-inhibiting agent, the cleaning composition may corrode the conductive structure. In addition, when the cleaning composition comprises more than about 5 percent by weight of the first corrosion-inhibiting agent, the corrosion-inhibiting effect of the cleaning composition may not substantially increase relative to when it comprises less than that amount, and the first corrosion-inhibiting agent may remain on the conductive structure to the detriment of the reliability of a semiconductor device comprising the conductive structure. Thus, the cleaning composition, in accordance with an exemplary embodiment, comprises about 0.1 to 5 percent by weight of the first corrosion-inhibiting agent, and preferably about 0.5 to 3 percent by weight of the first corrosion-inhibiting agent.

As mentioned previously, the first corrosion-inhibiting agent may comprise, for example, at least one of alkanesulfonic acid, carboxylic acid, alcohol, etc. The alkanesulfonic acid may comprise, for example, at least one of methanesulfonic acid, ethanesulfonic acid, propanesulfonic acid, butanesulfonic acid, etc. The carboxylic acid may comprise, for example, at least one of acetic acid, propionic acid, butyric acid, oxalic acid, malonic acid, maleic acid, succinic acid, glutaric acid, adipic acid, phthalic acid, fumaric acid, etc. The alcohol may comprise, for example, at least one of 1,4-buthanediol; 1,3-propanediol; 1,2-butanediol; 1,3-butanediol; 2,3-butanediol; catechol; etc.

The second corrosion-inhibiting agent may be adsorbed onto a surface of the conductive structure to reduce the amount that the cleaning composition corrodes the conductive structure. The second corrosion-inhibiting agent may also adjust the zeta potential of the particles to reduce amount of particle contamination.

When the cleaning composition, in accordance with an exemplary embodiment of the present invention, comprises less than about 0.0001 percent by weight of the second corrosion-inhibiting agent, the cleaning composition may corrode the conductive structure. In addition, when the cleaning composition comprises more than about 10 percent by weight of the second corrosion-inhibiting agent, the corrosion-inhibiting effect may not substantially increase relative to when the cleaning composition comprises less than that amount, and the second corrosion-inhibiting agent may remain on the conductive structure to the detriment of the reliability of a semiconductor device that comprises the conductive structure. Thus, the cleaning composition, in accordance with an exemplary embodiment of the present invention, comprises about 0.0001 to 10 percent by weight of the second corrosion-inhibiting agent, and preferably about 0.0002 to 1 percent by weight of the second corrosion-inhibiting agent.

The second corrosion-inhibiting agent may comprise, for example, a nonionic surfactant. Exemplary nonionic surfactants are, for example, NCW-1002 (trade name; manufactured by Wako Co., Japan), a block copolymer of polyethylene glycol and polypropylene glycol, etc. The block copolymer of polyethylene glycol and polypropylene glycol may comprise, for example, at least one of Synperonic PE/F68, Synperonic PE/L61, Synperonic PE/L64 (trade names; manufactured by Fluka Co., Germany), etc.

In another exemplary embodiment of the present invention, the cleaning composition comprises about 0.1 to 5 percent by weight of an alkylammonium hydroxide, about 0.01 to 2 percent by weight of a fluorine-containing compound, about 0.1 to 5 percent by weight of a buffering agent, about 0.1 to 5 percent by weight of a first corrosion-inhibiting agent, and a remainder of pure water. The first corrosion-inhibiting agent may comprise, for example, at least one of alkanesulfonic acid, carboxylic acid, alcohol, etc. The alkylammonium hydroxide, the fluorine-containing compound, the buffering agent, the first corrosion-inhibiting agent, and pure water have been described previously, so further description of those elements will be omitted here.

In yet another exemplary embodiment of the present invention, the cleaning composition comprises about 0.1 to 5 percent by weight of an alkylammonium hydroxide, about 0.01 to 2 percent by weight of a fluorine-containing compound, about 0.1 to 5 percent by weight of a buffering agent, about 0.0001 to 10 percent by weight of a second corrosion-inhibiting agent, and a remainder of pure water. A surfactant is an exemplary second corrosion-inhibiting agent. The alkylammonium hydroxide, the fluorine-containing compound, the buffering agent, the second corrosion-inhibiting agent, and pure water have been described previously, so further description of those elements will be omitted here.

In still another exemplary embodiment of the present invention, the cleaning composition comprises about 0.1 to 5 percent by weight of an alkylammonium hydroxide, about 0.01 to 2 percent by weight of a fluorine-containing compound, about 0.1 to 5 percent by weight of a buffering agent, about 0.1 to 5 percent by weight of a first corrosion-inhibiting agent, about 0.0001 to 10 percent by weight of a second corrosion-inhibiting agent, and a remainder of pure water. The first corrosion-inhibiting agent may comprise, for example, at least one of alkanesulfonic acid, carboxylic acid, alcohol, etc. A surfactant is an exemplary the second corrosion-inhibiting agent. The alkylammonium hydroxide, the fluorine-containing compound, the buffering agent, the first corrosion-inhibiting agent, the second corrosion-inhibiting agent, and pure water have been described previously, so further description of those elements will be omitted here.

In accordance with an exemplary embodiment of the present invention, the cleaning composition may have a pH of about 4 to 11. When the cleaning composition has a pH of less than about 4, the conductive structure and/or the substrate may be contaminated by particles. In addition, when the pH of the cleaning composition is greater than about 11, the cleaning composition may damage the conductive structure when the conductive structure comprises a metal such as aluminum, tungsten, etc. Therefore, the cleaning composition, in accordance with an exemplary embodiment of the present invention, may have a pH of about 4 to 11.

When the first corrosion-inhibiting agent, in an exemplary embodiment of the present invention, comprises alkanesulfonic acid and/or carboxylic acid, the cleaning composition may have a pH of about 4 to 8, and preferably about 4.5 to 6. When the first corrosion-inhibiting agent, in an exemplary embodiment of the present invention, comprises alcohol, the cleaning composition may have a pH of about 8 to 11.

### Exemplary Method for Preparing a Cleaning Composition

In accordance with an exemplary embodiment of the present invention, a method for preparing a cleaning composition (i.e., a cleaning composition in accordance with an exemplary embodiment of the present invention) will now be described. In the method for preparing the cleaning composition, an ammonium fluoride aqueous solution is prepared by mixing about 0.1 to 5 percent by weight of an alkylammonium hydroxide, about 0.01 to 2 percent by weight of a fluorine-containing compound, and about 73 to 99.7899 percent by weight of pure water. The method for preparing the cleaning composition further comprises adding about 0.1 to 5 percent by weight of a buffering agent and about 0.0001 to 15 percent by weight of a corrosion-inhibiting agent to about 80 to 99.8999 percent by weight of the ammonium fluoride aqueous solution. The alkylammonium hydroxide, the fluorine-containing compound, pure water, the buffering agent, and the corrosion-inhibiting agent have been described previously, so further description in these regards will be omitted here.

The ammonium fluoride aqueous solution and the cleaning composition may be prepared using a stirrer or a circulation system. The ammonium fluoride aqueous solution prepared in this way may have a pH of about 8 to 12, and the cleaning composition prepared in this way may have a pH of about 4 to 11.

In accordance with another exemplary embodiment of the present invention, a method for preparing a cleaning composition comprising a corrosion-inhibiting agent that comprises a first corrosion-inhibiting agent and a second corrosion-inhibiting agent comprises adding the second corrosion-inhibiting agent to the ammonium fluoride aqueous solution to form a first resulting solution, and adding the first corrosion-inhibiting agent and the buffering agent to the first resulting solution. The first and the second corrosion-inhibiting agents have been described previously, so further description in these regards will be omitted here.

When, for example, the cleaning composition comprises alkanesulfonic acid and/or carboxylic acid as the first corrosion-inhibiting agent, the second corrosion-inhibiting agent is added to the ammonium fluoride aqueous solution to stabilize the first resulting solution. The first corrosion-inhibiting agent and the buffering agent are added to the first resulting solution to adjust the pH of the cleaning composition to about 4 to 8, and preferably to about 4.5 to 6. Also, when the cleaning composition comprises alcohol as the first corrosion-inhibiting agent, the second corrosion-inhibiting agent is added to the ammonium fluoride aqueous solution to stabilize the first resulting solution. When the first corrosion-inhibiting agent comprises alcohol, the first corrosion-inhibiting agent and the buffering agent are added to the first resulting solution to adjust the pH of the cleaning composition to about 8 to 11.

In accordance with another exemplary embodiment of the present invention, a method of preparing a cleaning composition comprising the first corrosion-inhibiting agent as the corrosion-inhibiting agent comprises adding the buffering agent and the first corrosion-inhibiting agent to the ammonium fluoride aqueous solution. The cleaning composition thus prepared may have a pH substantially the same as that of the cleaning composition comprising the corrosion-inhibiting agent that comprises the first and the second corrosion-inhibiting agents.

In accordance with yet another exemplary embodiment of the present invention, a method of preparing a cleaning composition comprising the second corrosion-inhibiting agent as the corrosion-inhibiting agent comprises adding the second corrosion-inhibiting agent to the ammonium fluoride aqueous solution to form a second resulting solution, and adding the buffering agent to the second resulting solution. The cleaning composition prepared in this way may have a pH of about 4 to 11.

### Exemplary Method of Cleaning a Substrate

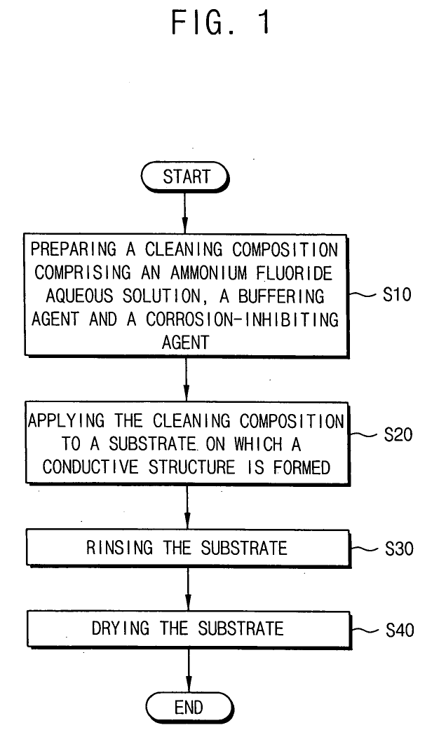

FIG. 1 is a flow chart illustrating a method of cleaning a substrate on which a conductive structure is formed using a cleaning composition in accordance with an exemplary embodiment of the present invention.

Referring to FIG. 1, first, a cleaning composition in accordance with an exemplary embodiment of the present invention comprising an ammonium fluoride aqueous solution, a buffering agent, and a corrosion-inhibiting agent is prepared (S10). The prepared cleaning composition comprises about 80 to 99.8999 percent by weight of the ammonium fluoride aqueous solution, about 0.1 to 5 percent by weight of the buffering agent, and about 0.0001 to 15 percent by weight of the corrosion-inhibiting agent. The cleaning composition and the method of preparing the cleaning composition have been described previously, so additional description thereof will be omitted here.

The cleaning composition is then applied to a substrate, on which a conductive structure is formed, wherein polymer remains on the substrate (S20). Accordingly, the polymer is removed from the substrate, and a corrosion-inhibition layer is formed on the conductive structure.

The conductive structure formed on the substrate may be, for example, a gate electrode, a bit line electrode, a wiring, a pad, a contact, a plug, etc. The conductive structure may comprise a conductive layer pattern. The conductive layer pattern may be formed using a conductive material such as a metal, a conductive metal nitride, a metal silicide, polysilicon doped with impurities, etc. The metal may be, for example, tungsten, titanium, aluminum, cobalt, copper, tantalum, etc. The conductive metal nitride may be, for example, titanium aluminum nitride, aluminum nitride, titanium nitride, titanium silicon nitride, tantalum nitride, tantalum silicon nitride, tungsten nitride, etc. The metal silicide may be, for example, tungsten silicide, titanium silicide, cobalt silicide, etc.

The cleaning composition may be applied to the substrate using a batch-type cleaning apparatus or a single-type cleaning apparatus. In addition, the cleaning composition may be applied to the substrate using a spin spray-type cleaning apparatus, a spin-type cleaning apparatus, a dipping-type cleaning apparatus, an ultrasonic spin-type cleaning apparatus, or an ultrasonic dipping-type cleaning apparatus.

When the cleaning composition applied to the substrate has a temperature of less than about 10° C., a cleaning time needed to remove the polymer may be longer than it would be if the temperature were not less than about 10° C. However, when the temperature of the cleaning composition is greater than about 50° C., though the polymer may be removed rapidly, the conductive structure may be damaged in the process. Thus, the cleaning composition applied to the substrate may have a temperature of about 10° C. to 50° C.

The cleaning time may be adjusted in accordance with the temperature of the cleaning composition. For example, when the temperature of the cleaning composition is room temperature, the cleaning composition is applied to the substrate for about 5 to 20 minutes, and preferably for about 8 to 12 minutes.

After the cleaning composition is applied to the substrate, the substrate is rinsed using pure water (S30). Accordingly, remaining polymer, particles, the corrosion-inhibition layer, and the cleaning composition may be removed from the substrate and/or the conductive structure.

The polymer that remains on the conductive structure may be dissolved in the cleaning composition or may be weakly adsorbed onto the conductive structure. When the substrate is rinsed using pure water, most of the remaining polymer may be removed from the substrate and/or the conductive structure. Simultaneously, the corrosion-inhibition layer and the cleaning composition may be removed from the substrate and/or the conductive structure.

The substrate is then dried to remove remaining pure water (S40).

When the substrate is cleaned using a cleaning composition in accordance with an exemplary embodiment of the present invention, the polymer may be effectively removed from the substrate and/or the conductive structure with reduced damage to the conductive structure.

### Method of Manufacturing a Semiconductor Device

A method of manufacturing a substrate using a cleaning composition in accordance with an exemplary embodiment of the present invention will be described hereinafter with reference to the accompanying drawings.

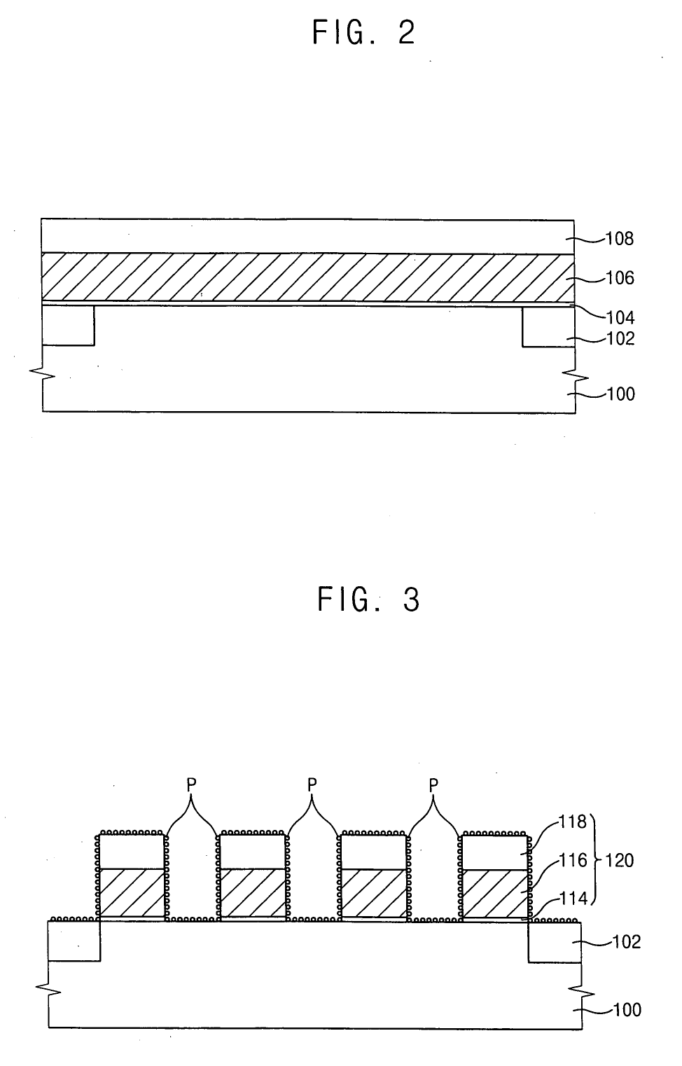

FIGS. 2 through 5 are cross-sectional views illustrating a method of forming a word line in a semiconductor device using a cleaning composition in accordance with an exemplary embodiment of the present invention. Though multiple word lines may be formed through the method described below, the method will be described with reference to a single word line.

FIG. 2 is a cross-sectional view illustrating a method of forming an isolation layer 102 in a substrate 100; and forming an oxide layer 104, a conductive layer 106, and a mask layer 108 on substrate 100.

Referring to FIG. 2, oxide layer 104, conductive layer 106, and mask layer 108 are successively formed on substrate 100, in which isolation layer 102 is formed.

Isolation layer 102 is formed in an upper portion of substrate 100 to define an active region and a field region. Substrate 100 may be, for example, a silicon wafer, or a silicon-on-insulator (SOI) substrate. Isolation layer 102 may be formed through a shallow trench isolation (STI) process.

Oxide layer 104 is then formed on substrate 100. Oxide layer 104 may be formed through an oxidation process such as a thermal oxidation process or a plasma oxidation process, or through a chemical vapor deposition (CVD) process. For example, oxide layer 104 may be formed through a rapid thermal oxidation process or a furnace thermal oxidation process.

Conductive layer 106 is formed on oxide layer 104. Conductive layer 106 may be formed using a conductive material such as metal, metal nitride, polysilicon doped with impurities, metal silicide, etc. Also, conductive layer 106 may be formed through a sputtering process, an atomic layer deposition (ALD) process, or a CVD process.

Mask layer 108 is formed on conductive layer 106. Mask layer 108 may be formed using a material that has an etching selectivity relative to an insulating interlayer that will be subsequently formed. For example, when the insulating interlayer is formed using oxide, mask layer 108 is formed using a nitride such as silicon nitride.

FIG. 3 is a cross-sectional view illustrating the formation of a gate structure 120 through an etching process.

Referring to FIGS. 2 and 3, mask layer 108, conductive layer 106, and oxide layer 104 are successively dry etched to form gate structure 120, comprising an oxide layer pattern 114, a conductive layer pattern 116, and a mask pattern 118, on substrate 100. Gate structure 120 corresponds to a word line in a semiconductor device.

To form gate structure 120 on substrate 100, a photoresist pattern (not shown) is formed on mask layer 108. Mask layer 108, conductive layer 106, and oxide layer 104 are then successively dry etched using the photoresist pattern as an etching mask. In the etching process, mask layer 108 is patterned to form mask pattern 118, conductive layer 106 is patterned to form conductive layer pattern 116, and oxide layer 104 is patterned to form oxide layer pattern 114.

After the etching process, a large amount of polymer P remains on substrate 100 and gate structure 120. Polymer P may be, for example, etching residues generated in the dry etching process, organic residues generated from the photoresist pattern, metallic residues generated from conductive layer 106, and/or oxide residues generated from oxide layer 104. That is, polymer P may comprise organic polymer, metallic polymer, and/or oxide polymer.

Polymer P remains on gate structure 120 and raises the electrical resistance of the semiconductor device or generates an electric short between adjacent word lines.

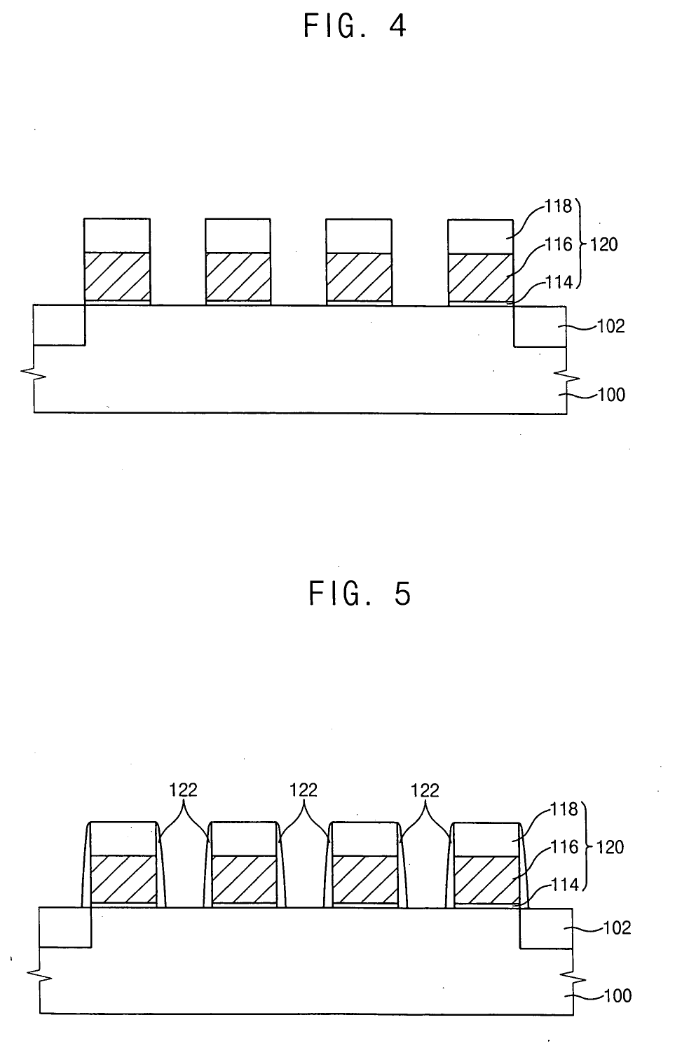

FIG. 4 is a cross-sectional view illustrating the removal of polymer P from substrate 100 and gate structure 120.

Referring to FIGS. 3 and 4, polymer P is removed from substrate 100 and/or gate structure 120 through a cleaning process with reduced damage to conductive layer pattern 116 or oxide layer pattern 114. The cleaning process will be described in more detail hereinafter.

The cleaning composition, in accordance with an exemplary embodiment of the present invention, is provided onto substrate 100 on which gate structure 120 is formed. The cleaning composition, in accordance with an exemplary embodiment of the present invention, comprises about 80 to 99.8999 percent by weight of an ammonium fluoride aqueous solution, about 0.1 to 5 percent by weight of a buffering agent and about 0.0001 to 15 percent by weight of a corrosion-inhibiting agent. The cleaning composition and the method of preparing the cleaning composition have been described previously, so further description in these regards will be omitted here.

Using the cleaning composition, polymer P is removed from substrate 100 and/or gate structure 120 with reduced damage to conductive layer pattern 116 or oxide layer pattern 114. The cleaning process may be performed using a batch-type cleaning apparatus or a single-type cleaning apparatus.

In an exemplary embodiment of the present invention, substrate 100, on which gate structure 120 is formed, is introduced into the single-type cleaning apparatus. Then, the cleaning composition having a temperature of about 10° C. to 50° C. is applied onto substrate 100. While rotating or stopping substrate 100, the cleaning composition may make contact with substrate 100. The cleaning composition may make contact with substrate 100 for about 5 to 20 minutes, and preferably for about 8 to 12 minutes, to remove polymer P from substrate 100 and gate structure 120.

Polymer P may be removed by the ammonium fluoride aqueous solution in the cleaning composition. The corrosion-inhibiting agent may be adsorbed onto gate structure 120 comprising conductive layer pattern 116 to form a corrosion-inhibition layer on gate structure 120. Accordingly, the corrosion-inhibiting agent may reduce the amount of damage caused to gate structure 120. In addition, an additional corrosion-inhibition layer may be formed on an exposed portion of gate structure 120 from which polymer P is removed.

Substrate 100 may be rinsed using pure water (e.g. deionized water) to remove polymer P, particles, and the cleaning composition from substrate 100. Polymer P may be dissolved in the cleaning composition or may be weakly adsorbed onto substrate 100 and gate structure 120. When substrate 100 is rinsed using pure water, most of the remaining polymer may be removed from substrate 100 and gate structure 120. Substrate 100 may be dried to remove the pure water from substrate 100.

FIG. 5 is a cross-sectional view illustrating the formation of a spacer 122 on a sidewall of gate structure 120.

Referring to FIGS. 4 and 5, an insulation layer is formed on gate structure 120, from which polymer P (of FIG. 3) was removed in the cleaning process, and then the insulation layer is anisotropically etched to form spacer 122 on the sidewall of gate structure 120.

Agate structure 120 may be electrically separated from an adjacent gate structure 120 by a spacer 122. Impurities are implanted into a portion of substrate 100 that is exposed between adjacent gate structures 120, and then substrate 100 is thermally treated to form a source/drain region (not shown) at a surface portion of substrate 100 adjacent to gate structures 120. The word line in the semiconductor device is completed accordingly.

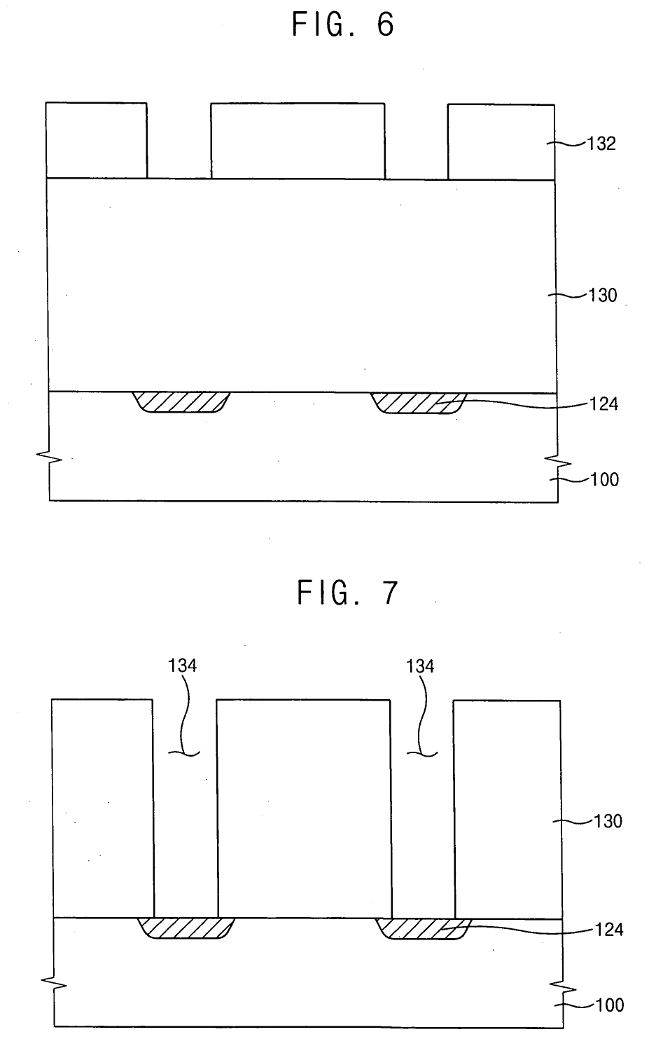

FIGS. 6 through 13 are cross-sectional views illustrating a method of forming a bit line in a semiconductor device using a cleaning composition in accordance with an exemplary embodiment of the present invention. Though multiple bit lines may be formed through the method described below, the method will be described with reference to a single bit line.

FIG. 6 is a cross-sectional view illustrating the formation of an insulating interlayer 130 and a first photoresist pattern 132 on a substrate 100.

Referring to FIG. 6, insulating interlayer 130 is formed on substrate 100. The word line portion illustrated in FIG. 5 may be formed on substrate 100. First photoresist pattern 132 is formed on insulating interlayer 130.

Insulating interlayer 130 is formed on substrate 100 using an oxide. The oxide may comprise, for example, at least one of borophosphosilicate glass (BPSG), phosphosilicate glass (PSG), undoped silicate glass (USG), spin-on glass (SOG), flowable oxide (FOX), plasma enhanced-tetraethyl orthosilicate (PE-TEOS), high density plasma-chemical vapor deposition (HDP-CVD) oxide, etc.

To form first photoresist pattern 132 on insulating interlayer 130, a first photoresist film is first formed on insulating interlayer 130, and then the first photoresist film is partially removed to form first photoresist pattern 132. In the illustrated embodiment, first photoresist pattern 132 exposes a portion of insulating interlayer 130 at which a contact hole 134 (see FIG. 7) will be formed to expose a contact region 124. Contact region 124 may correspond to the source/drain region of the word line illustrated in FIG. 5.

FIG. 7 is a cross-sectional view illustrating the formation of contact hole 134 in insulating interlayer 130.

Referring to FIGS. 6 and 7, insulating interlayer 130 is partially etched to form contact hole 134 exposing contact region 124. To form contact hole 134, insulating interlayer 130 may be anisotropically etched using first photoresist pattern 132 as an etching mask. First photoresist pattern 132 may be removed through an ashing process and/or a stripping process.

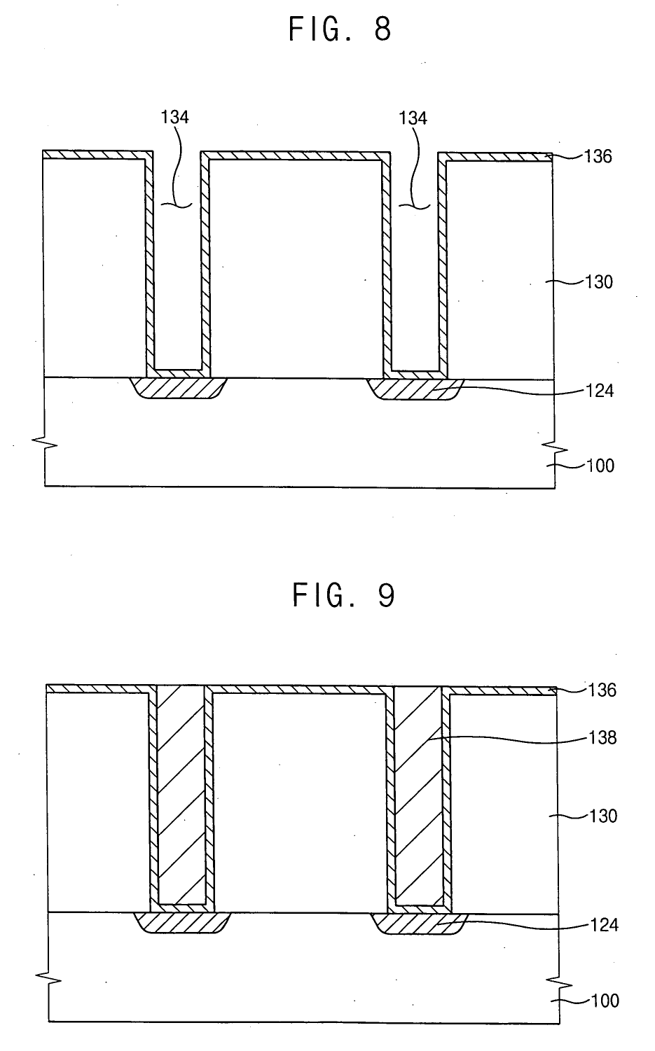

FIG. 8 is a cross-sectional view illustrating the formation of a barrier layer 136 on insulating interlayer 130 comprising contact hole 134.

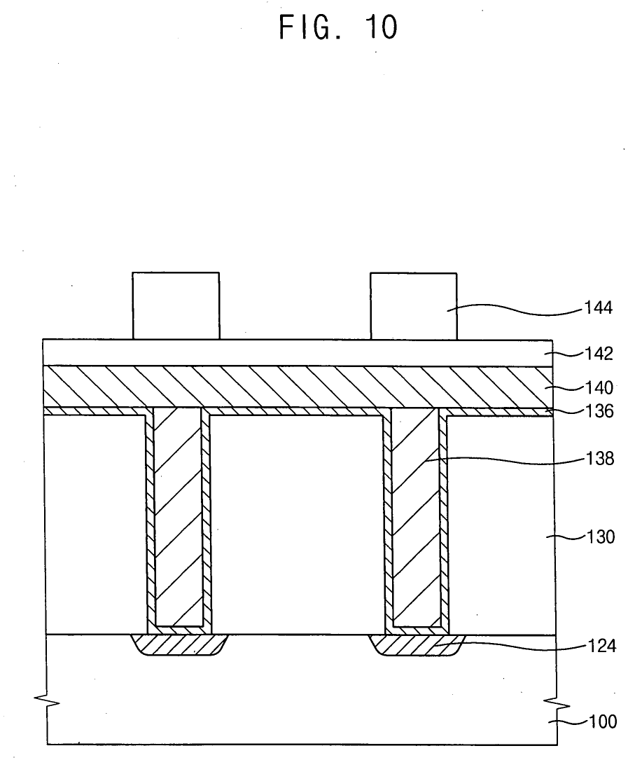

Referring to FIG. 8, barrier layer 136 is formed on insulating interlayer 130 and on a bottom and sidewalls of contact hole 134. Barrier layer 136 may prevent the conductive material of a pad 138 (see FIG. 9), which is formed subsequently, from diffusing into insulating interlayer 130. Barrier layer 136 is formed using, for example, titanium and titanium nitride.

FIG. 9 is a cross-sectional view illustrating the formation of pad 138 to fill contact hole 134.

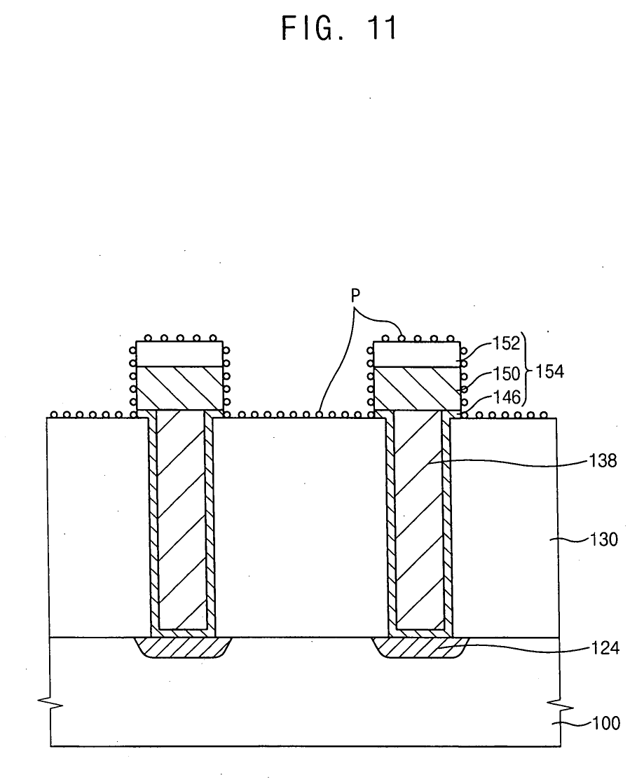

Referring to FIGS. 8 and 9, contact hole 134 is filled with a conductive material to form pad 138, which contacts contact region 124, and or barrier layer 136. Pad 138 may be formed using a metal such as tungsten or aluminum. Pad 138 may electrically connect a bit line 154 (see FIG. 11) to contact region 124.

FIG. 10 is a cross-sectional view illustrating the formation of a conductive layer 140, a mask layer 142, and a second photoresist pattern 144 on barrier layer 136 and pad 138.

Referring to FIGS. 9 and 10, conductive layer 140, mask layer 142, and second photoresist pattern 144 are successively formed on barrier layer 136 and pad 138.

Particularly, conductive layer 140 may be formed using a metal or conductive metal nitride. Conductive layer 140 may be formed using tungsten, for example. Mask layer 142 may be formed using a nitride such as silicon nitride. Second photoresist pattern 144 may be used as an etching mask in an etching process for forming bit line 154 (see FIG. 11).

FIG. 11 is a cross-sectional view illustrating the formation of bit line 154 on pad 138.

Referring to FIGS. 10 and 11, mask layer 142 and conductive layer 140 are successively etched using second photoresist pattern 144 as an etching mask to form bit line 154 on pad 138 and insulating interlayer 130. Bit line 154 comprises a barrier layer pattern 146, a conductive layer pattern 150, and a mask pattern 152. Bit line 154 makes contact with pad 138 so that bit line 154 is electrically connected to contact region 124.

Bit line 154 may be formed by dry etching mask layer 142 and conductive layer 140 using second photoresist pattern 144 as an etching mask. Second photoresist pattern 144 may be removed through an ashing process and/or a stripping process.

After performing the etching process for forming bit line 154, a large amount of polymer P remains on bit line 154 and insulating interlayer 130. Polymer P may be, for example, organic polymer, oxide polymer, and/or a metallic polymer. Polymer P remaining on bit line 154 raises the electrical resistance of the semiconductor device comprising bit line 154 and generates an electrical short between adjacent bit lines. Therefore, the removal of polymer P may be required necessary.

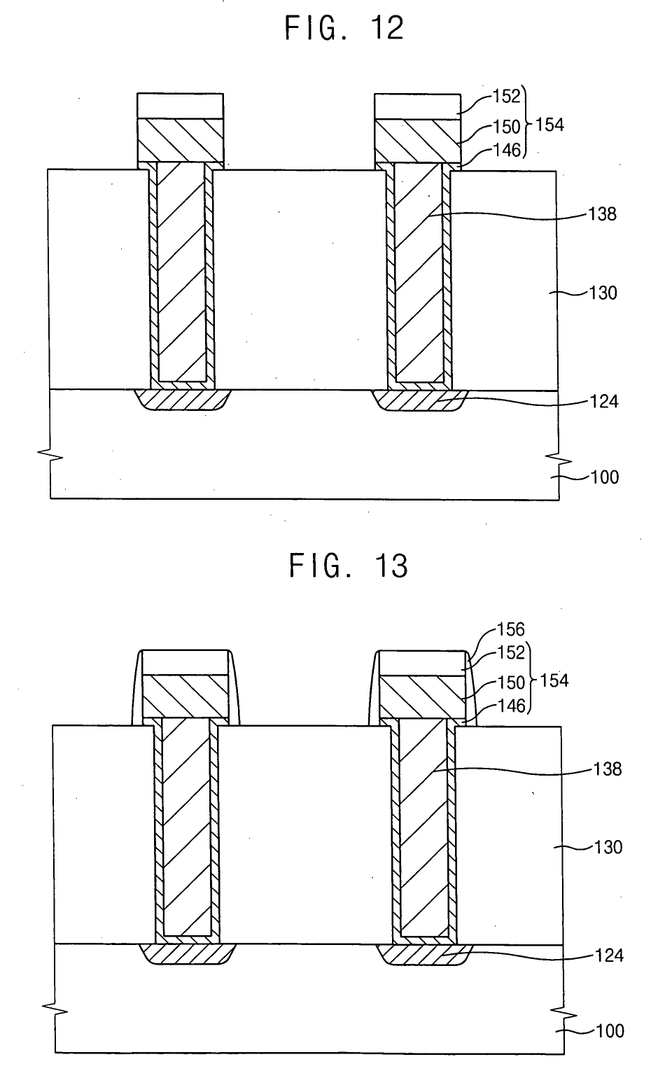

FIG. 12 is a cross-sectional view illustrating the removal of polymer P from bit line 154.

Referring to FIGS. 11 and 12, polymer P is removed from bit line 154 and insulating interlayer 130 through a cleaning process without damaging bit line 154 or insulating interlayer 130.

The cleaning composition for removing polymer P is provided onto substrate 100, on which bit line 154 is formed. The cleaning composition, in accordance with an exemplary embodiment of the present invention, comprises about 80 to 99.8999 percent by weight of an ammonium fluoride aqueous solution, about 0.1 to 5 percent by weight of a buffering agent and about 0.0001 to 15 percent by weight of a corrosion-inhibiting agent. The cleaning composition and the method of preparing the cleaning composition have been described previously, so further description thereof will be omitted here.

Polymer P is removed from bit line 154 using the cleaning composition. The cleaning process may be performed using a batch-type cleaning apparatus or a single-type cleaning apparatus. The cleaning process for removing polymer P from bit line 154 is substantially the same as the cleaning process for removing polymer P from gate structure 120, which was described with reference to FIGS. 3 and 4, so further description thereof will be omitted here.

FIG. 13 is a cross-sectional view illustrating the formation of a bit line spacer 156 on a sidewall of bit line 154.

Referring to FIG. 13, bit line spacer 156 is formed on the sidewall of bit line 154. Bit line spacer 156 may be formed using a nitride such as silicon nitride. Bit line spacer 156 may be formed by, for example, forming a silicon nitride layer on bit line 154 and then performing an etch back process. Polymer P may be removed from bit line 154 with reduced damage to bit line 154, so the semiconductor device comprising bit line 154 may have enhanced electrical characteristics.

Methods of forming a word line and a bit line using the cleaning composition in accordance with an exemplary embodiment of the present invention have been described herein, but a wiring, a pad, a plug, and a contact may also be formed using the cleaning composition in accordance with an exemplary embodiment of the present invention.

The cleaning composition in accordance with exemplary embodiments of the present invention will be described hereinafter with reference to several Examples and Comparative Examples.

### Exemplary Cleaning Composition Comparisons

### EXAMPLE 1

A cleaning composition was prepared using about 1 percent by weight of tetramethylammonium hydroxide, about 0.1 percent by weight of hydrogen fluoride, about 1.2 percent by weight of a buffering agent, about 0.001 percent by weight of a corrosion-inhibiting agent, and a remainder of pure water, based on the total weight of the cleaning composition. Ammonium nitrate was used as the buffering agent, and an anionic surfactant was used as the corrosion-inhibiting agent. NCW-1002 (trade name; manufactured by Wako Co., Japan) was used as the anionic surfactant. In preparing the cleaning composition, an ammonium fluoride aqueous solution was prepared by mixing tetramethylammonium hydroxide (TMAH), hydrogen fluoride, and pure water; and then the buffering agent and the corrosion-inhibiting agent were added to the ammonium fluoride aqueous solution. The cleaning composition thus prepared had a pH of about 10.5.

### EXAMPLES 2 THROUGH 7

Cleaning compositions were prepared by processes substantially the same as those described with reference to Example 1 except for the amount (i.e., content) of hydrogen fluoride, and the type and amount of the corrosion-inhibiting agent in the cleaning compositions of Examples 2 through 7. The types and amounts of the components in and the pH levels of the cleaning compositions prepared in Examples 1 through 7 are shown in Table 1.

### COMPARATIVE EXAMPLES 1 THROUGH 5

To form Comparative Examples 1 through 5, cleaning compositions were prepared by processes substantially the same as those described with reference to Example 1 except for the amounts (i.e., contents), if any, of hydrogen fluoride, the buffering agent, and the corrosion-inhibiting agent in the cleaning compositions of Comparative Examples 1 through 5. The amounts of the components in and the pH levels of the cleaning compositions prepared in Comparative Examples 1 to 5 are shown in Table 1.

### COMPARATIVE EXAMPLE 6

A standard cleaning solution 1 (SC-1) was prepared as a cleaning composition for Comparative Example 6. The SC-1 was prepared by mixing ammonium hydroxide (NH₄OH), hydrogen peroxide (H₂O₂), and deionized water with a molar ratio of about 1:1:5.

TABLE 1

| | Ammonium Fluoride | | Buffering | | | | |
|---|---|---|---|---|---|---|---|
| | Aqueous Solution | | Agent | Corrosion-Inhibiting Agent | | | |
| | TMAH | HF | Ammonium | 1st Corrosion-Inhibiting | | Surfactant | |
| | [wt %] | [wt %] | Nitrate [wt %] | Agent [wt %] | | [wt %] | pH |
| Example 1 | 1 | 0.1 | 1.2 | — | | 0.001 | 10.5 |
| Example 2 | 1 | 0.2 | 1.2 | — | | 0.001 | 5.0 |
| Example 3 | 1 | 0.1 | 1.2 | Ethanesulfonic | 1.2 | — | 5.0 |
| | | | | Acid | | | |
| Example 4 | 1 | 0.1 | 1.2 | Ethanesulfonic | 1.2 | 0.001 | 5.0 |
| | | | | Acid | | | |
| Example 5 | 1 | 0.4 | 1.2 | Ethanesulfonic | 0.95 | 0.001 | 5.0 |
| | | | | Acid | | | |
| Example 6 | 1 | 0.1 | 1.2 | Acetic Acid | 0.9 | 0.001 | 5.0 |
| Example 7 | 1 | 0.1 | 1.2 | 1,4-Buthanediol | 2.5 | 0.001 | 10.0 |

| | | | | | | |
|---|---|---|---|---|---|---|
| Comparative | 1 | — | — | — | — | >13 |
| Example 1 | | | | | | |
| Comparative | 1 | — | 2 | — | 0.001 | 10.5 |
| Example 2 | | | | | | |
| Comparative | 1 | 0.3 | — | — | 0.001 | 10.5 |
| Example 3 | | | | | | |
| Comparative | 1 | 0.1 | 1.2 | — | — | 10.5 |
| Example 4 | | | | | | |
| Comparative | 1 | 0.5 | — | — | 0.001 | 5.0 |
| Example 5 | | | | | | |

### Exemplary Abilities of Cleaning Compositions to Remove Particles

The ability of each of the cleaning compositions prepared in Examples 1 through 5, and Comparative Examples 1, 3, and 5 to remove particles was evaluated. To evaluate the ability of each of the cleaning compositions to remove particles, a thermal oxide layer was formed on each of a plurality of bare silicon wafers. Each thermal oxide layer thus formed had a thickness of about 1,000 Å. Silicon powder and polystyrene latex (PSL) particles were dispersed in deionized water with a concentration of about 100 parts per billion to prepare a suspension solution. After the silicon wafers on which the thermal oxide layers were formed were immersed in the suspension solution, the silicon wafers were dried. Accordingly, silicon wafers contaminated by particles were prepared.

Particle contamination of each silicon wafer was analyzed using surface inspection equipment. Particularly, the number of particles on each silicon wafer was counted using SP1 (trade name; manufactured by KLA-Tencor Co., Japan). Particles having a diameter greater than about 0.065 μm were counted.

After the silicon wafers contaminated by particles were immersed in the cleaning compositions prepared in Examples 1 through 5 and Comparative Examples 1, 3, and 5 at room temperature for about 10 minutes, the silicon wafers were rinsed using deionized water. After the cleaning process, the number of particles on each silicon wafer was counted using the surface inspection equipment. A particle removal ratio was calculated from the number of particles present on each silicon wafer before and after the cleaning process. The particle removal ratios are shown in Table 2.

TABLE 2

| | Particle Removal Ratio [%] |
|---|---|
| Example 1 | 60 |
| Example 2 | 43 |
| Example 3 | 50 |
| Example 4 | 61 |
| Example 5 | 60 |
| Comparative Example 1 | 0 |
| Comparative Example 3 | 54 |
| Comparative Example 5 | 15 |

As shown in Table 2, the cleaning composition prepared in Comparative Example 1 did not remove particles from the silicon wafer, and the cleaning compositions prepared in Examples 1 through 5 effectively removed particles from the silicon wafer.

Particularly, the cleaning compositions prepared in Examples 1 and 2, each of which comprised the buffering agent, had particle removal ratios substantially higher than the particle removal ratios of the cleaning compositions prepared in Comparative Examples 3 and 5, respectively, which did not comprise the buffering agent. When the cleaning compositions prepared in Comparative Example 3 and Example 1 were compared with each other, both of the cleaning compositions had a pH of about 10.5, but the cleaning composition prepared in Example 1, which comprised the buffering agent, had a particle removal ratio substantially higher than the particle removal ratio of the cleaning composition prepared in Comparative Example 3, which did not comprise the buffering agent. In addition, when the cleaning compositions prepared in Comparative Example 5 and Example 2 were compared with each other, both of the cleaning compositions had a pH of about 5.0, but the cleaning composition prepared in Example 2, which comprised the buffering agent, had a particle removal ratio substantially higher than that of the cleaning composition prepared in Comparative Example 5, which did not comprise the buffering agent. Thus, the cleaning composition comprising the buffering agent, in accordance with an exemplary embodiment of the present invention, has an excellent ability to remove particles in a relatively wide pH range.

To estimate the respective abilities of the cleaning compositions to remove particles in accordance with the existence or absence of the buffering agent in the respective cleaning compositions, the surfaces (i.e., the working surfaces) of the silicon wafers cleaned using either the cleaning composition prepared in Example 1 or the cleaning composition prepared in Comparative Example 3 were inspected further using the surface inspection equipment. Pictures of the surfaces of the silicon wafers were taken using the SP1.

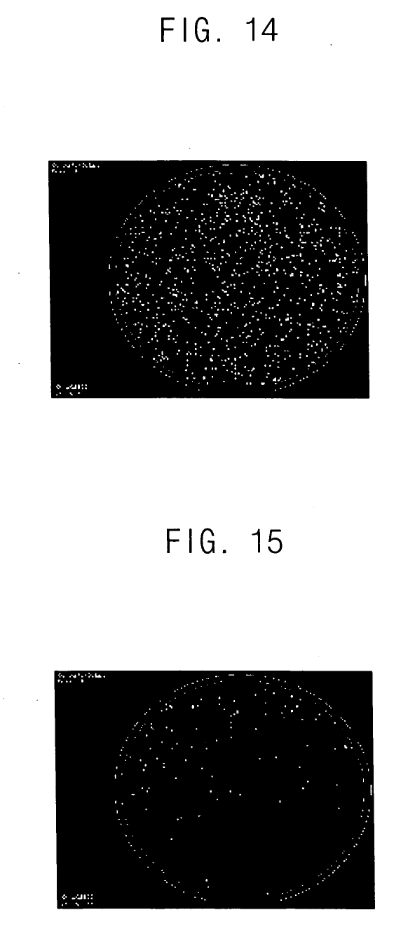

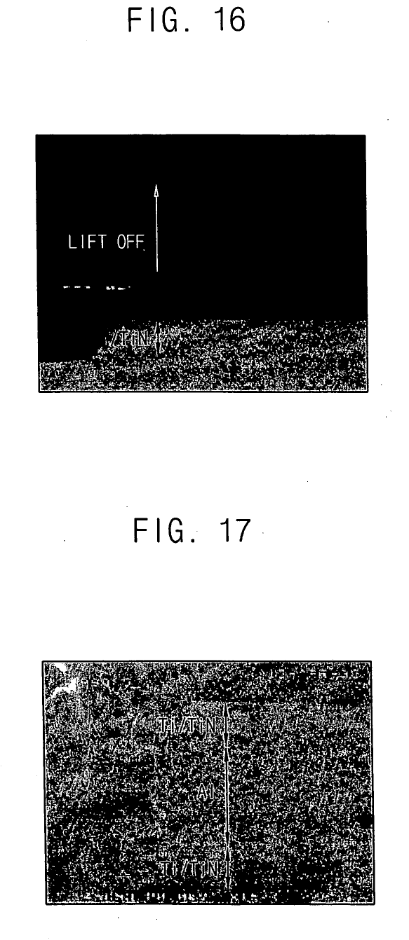

FIG. 14 is a picture of the surface of the silicon wafer cleaned using the cleaning composition prepared in Comparative Example 3, and FIG. 15 is a picture of the surface of the silicon wafer cleaned using the cleaning composition prepared in Example 1.

As shown in FIGS. 14 and 15, a relatively large number of particles remained on the silicon wafer that was cleaned using the cleaning composition prepared in Comparative Example 3, but a relatively small number of particles remained on the silicon wafer that was cleaned using the cleaning composition prepared in Example 1. Thus, the cleaning composition comprising the buffering agent, in accordance with an exemplary embodiment of the present invention, effectively removes particles from the silicon wafer. In particular, the buffering agent may control a zeta potential of a particle surface to prevent particles from being readsorbed onto the silicon wafer. Therefore, fabricating a semiconductor device using the cleaning composition in accordance with an exemplary embodiment of the present invention may reduce particle contamination and enhance the reliability of the semiconductor device.

### Evaluation of Damage to an Aluminum Layer Pattern

After cleaning aluminum layer patterns using the cleaning compositions prepared in Examples 1 through 5, and Comparative Examples 1 through 5, the damage to the aluminum layer patterns that resulted was evaluated.

To evaluate damage to aluminum layer patterns, conductive structures, each comprising an aluminum layer pattern, were formed on a plurality of silicon wafers. The formation of an aluminum layer on one silicon wafer will now be described. A first titanium/titanium nitride layer having a thickness of about 1,000 Å was formed on the silicon wafer, an aluminum layer having a thickness of about 3,000 Å was formed on the first titanium/titanium nitride layer, and a second titanium/titanium nitride layer having a thickness of about 1,000 Å was formed on the aluminum layer. The second titanium/titanium nitride layer, the aluminum layer, and the first titanium/titanium nitride layer were-successively etched through a dry etching process to form a conductive structure on the silicon wafer. The conductive structure comprised a first titanium/titanium nitride layer pattern, an aluminum layer pattern, and a second titanium/titanium nitride layer pattern. The conductive structure comprising the aluminum layer pattern may be used as a wiring in a semiconductor device.

Conductive structures, like the conductive structure described above, were then formed on silicon wafers, and then the silicon wafers were each respectively immersed in one of the cleaning composition prepared in Examples 1 through 5 and Comparative Examples 1 through 5. The silicon wafers were respectively immersed in the cleaning compositions at a room temperature for about 10 minutes. The silicon wafers were also rinsed using deionized water and dried. After the cleaning process, the conductive structures formed on the silicon wafers were observed using a scanning electron microscope (SEM). Damage to the aluminum layer patterns in the conductive structures was evaluated using the SEM pictures. The results are shown in Table 3.

TABLE 3

| | Damage to Aluminum Layer pattern |
|---|---|
| Example 1 | Δ |
| Example 2 | Δ |
| Example 3 | X |
| Example 4 | X |
| Example 5 | X |
| Comparative Example 1 | ◯ |
| Comparative Example 2 | Δ |
| Comparative Example 3 | Δ |
| Comparative Example 4 | ◯ |
| Comparative Example 5 | Δ |

In Table 3, ◯ indicates that the aluminum layer pattern was completely removed or severely damaged, Δ indicates that the aluminum layer pattern was slightly or partially damaged, and X indicates that the aluminum layer pattern was almost undamaged.

As shown in Table 3, the cleaning compositions prepared in Examples 1 through 5, which comprised the corrosion-inhibiting agent, caused less damage to the aluminum layer pattern than did the cleaning composition prepared in Comparative Example 4, which did not comprise the corrosion-inhibiting agent. When the cleaning compositions prepared in Comparative Example 4 and Example 1 were compared with each other, both of the cleaning compositions had a pH of about 10.5, but the cleaning composition prepared in Example 1, which comprised the corrosion-inhibiting agent, caused less damage to an aluminum layer pattern than did the cleaning composition prepared in Comparative Example 4, which did not comprise the corrosion-inhibiting agent. Thus, a cleaning composition in accordance with an exemplary embodiment of the present invention may effectively reduce the amount of damage caused to a conductive layer pattern such as an aluminum layer pattern.

In addition, when the cleaning compositions prepared in Examples 1 and 3 were compared with each other, the cleaning composition prepared in Example 3, which comprised an alkanesulfonic acid as the corrosion-inhibiting agent, was found to have damaged the aluminum layer pattern less than did the cleaning composition prepared in Example 1, which comprised a surfactant as the corrosion-inhibiting agent.

FIGS. 16 through 18 are SEM pictures of the aluminum layer patterns cleaned using the cleaning compositions prepared in Comparative Example 1, Example 2, and Example 4, respectively.

As shown in FIGS. 16 through 18, the aluminum layer pattern cleaned using the cleaning composition prepared in Comparative Example 1, which did not comprise the corrosion-inhibiting agent, was completely corroded and removed from the silicon wafer. However, the aluminum layer patterns cleaned using the cleaning composition prepared in Example 2 or the cleaning composition prepared in Example 4, each of which comprised the corrosion-inhibiting agent, were slightly damaged, but the whole shape of the aluminum layer pattern was maintained. Therefore, the cleaning compositions prepared in Examples 2 and 4, which comprise the corrosion-inhibiting agent, damage the aluminum layer pattern less than does the cleaning composition prepared in Comparative Example 1, which does not comprise the corrosion-inhibiting agent.

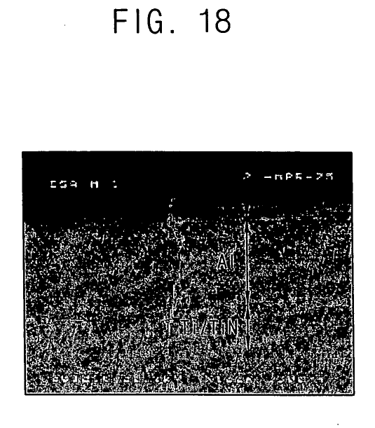

Additionally, when the cleaning compositions prepared in Examples 2 and 4 were compared with each other with reference to FIGS. 17 and 18, both of the cleaning compositions had a pH of about 5.0, but the cleaning composition prepared in Example 4, which comprised a corrosion-inhibiting agent comprising alkanesulfonic acid and a surfactant, damaged the aluminum layer pattern less than did the cleaning composition prepared in Example 2, which comprised a corrosion-inhibiting agent comprising only a surfactant. Thus, a cleaning composition that comprises a corrosion-inhibiting agent comprising alkanesulfonic acid and a surfactant prevents damage to the aluminum layer pattern more effectively than does a cleaning composition that comprises a corrosion-inhibiting agent comprising only a surfactant.

### Evaluation of Damage to a Tungsten Layer Pattern

Damage to a tungsten layer pattern in accordance with the type of corrosion-inhibiting agent in the cleaning composition was also evaluated. Tungsten layer patterns cleaned using the cleaning compositions prepared in Examples 2, 4, 6, and 7 were observed using the SEM.

To evaluate damage to a tungsten layer pattern, conductive structures, each comprising a tungsten layer pattern, were formed on silicon wafers. The formation of a tungsten layer on one silicon wafer will now be described. A titanium/titanium nitride layer having a thickness of about 500 Å was formed on the silicon wafer, a tungsten layer having a thickness of about 500 Å was formed on the titanium/titanium nitride layer, and a silicon nitride layer having a thickness of about 2,500 Å was formed on the tungsten layer. The silicon nitride layer, the tungsten layer, and the titanium/titanium nitride layer were successively etched through a dry etching process to form a conductive structure on the silicon wafer. The conductive structure comprised a titanium/titanium nitride layer pattern, a tungsten layer pattern, and a silicon nitride layer pattern. The conductive structure comprising the tungsten layer pattern may be used as a bit line in a semiconductor device.

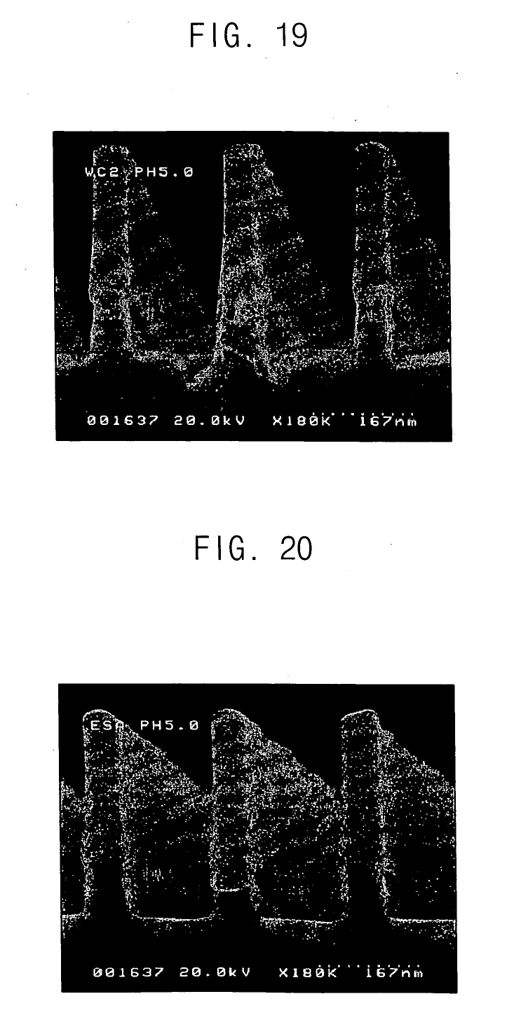

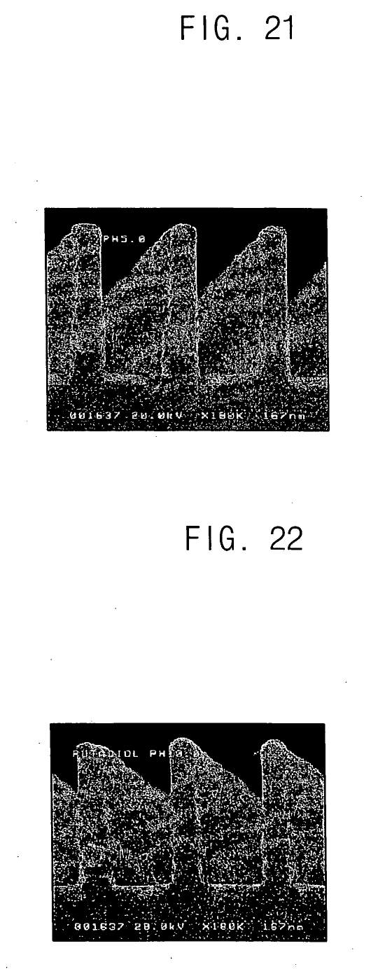

FIGS. 19 through 22 are SEM pictures of the tungsten layer patterns cleaned using the cleaning compositions prepared in Examples 2, 4, 6, and 7, respectively.

As shown in FIGS. 19 through 22, the tungsten layer pattern cleaned using the cleaning composition prepared in Example 2, which comprised a corrosion-inhibiting agent comprising only a surfactant, was slightly damaged, but the whole shape of the tungsten layer pattern was maintained. When the tungsten layer patterns were cleaned using cleaning compositions prepared in Examples 4, 6, and 7, each of which comprised both the first corrosion-inhibiting agent and the second corrosion-inhibiting agent (i.e., a surfactant), the tungsten layer patterns were almost undamaged. Ethanesulfonic acid, acetic acid, and 1,4-buthanediol were used as the first corrosion-inhibiting agent in the cleaning compositions prepared in Examples 4, 6, and 7, respectively. Therefore, the cleaning compositions comprising the corrosion-inhibiting agent, in accordance with exemplary embodiments of the present invention, effectively reduce the amount of damage caused to the tungsten layer pattern by the cleaning composition. Furthermore, a cleaning composition comprising both the first corrosion-inhibiting agent and the second corrosion-inhibiting agent more effectively prevents damage to the tungsten layer pattern than a cleaning composition comprising only the second corrosion-inhibiting agent (i.e., a surfactant).

### Evaluation of Ability to Prevent a Metallic Contamination

The respective abilities of the cleaning compositions to prevent metallic contamination were evaluated for the cleaning compositions prepared in Example 1, Example 2, Example 5, and Comparative Example 6. Several metal ions were dissolved in each of the cleaning compositions. The metal ions dissolved were ions of aluminum, titanium, chromium, iron, nickel, copper, zinc, and tungsten. Metal ions of each of the previously mentioned types were dissolved with a concentration of about 1,000 parts per billion. Bare silicon wafers were immersed in the cleaning compositions at a room temperature for about 10 minutes. The amounts of the metal ions remaining on the silicon wafers were then measured using an inductively coupled plasma-mass spectrometer (ICP-MS).

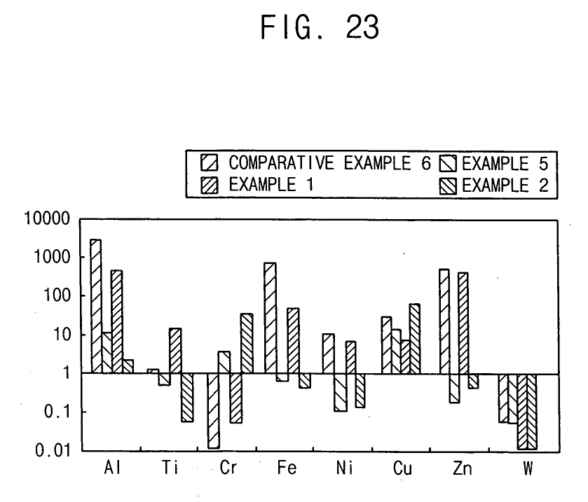

FIG. 23 is a graph showing the amounts of each type metal ion remaining on the silicon wafers, wherein each silicon wafer was cleaned using a cleaning composition prepared in Example 1, Example 2, Example 5, or Comparative Example 6.

As shown in FIG. 23, the amounts of aluminum, iron, nickel, zinc, and tungsten ions remaining on the silicon wafers cleaned using a cleaning composition prepared in Example 1, Example 2, or Example 5 were less than the amounts remaining on the silicon wafer cleaned using the cleaning composition prepared in Comparative Example 6. Thus, a cleaning composition comprising the ammonium fluoride aqueous solution, in accordance with an exemplary embodiment of the present invention, may reduce the amount that metal ions contaminate an object such as a silicon wafer.

In addition, the amount of metal ions (i.e., aluminum, iron, nickel, zinc, and tungsten ions) remaining on the silicon wafer cleaned using the cleaning composition prepared in Example 2, which comprised about 0.2 percent by weight of the fluorine-containing compound, were generally less than the amount remaining on the silicon wafer cleaned using the cleaning composition prepared in Example 1, which comprised about 0.1 percent by weight of the fluorine-containing compound. Thus, the ability to prevent metallic contamination may be controlled by changing the amount of the fluorine-containing compound that the cleaning composition comprises. Furthermore, the amount of metal ions (i.e., aluminum, iron, nickel, and zinc ions) remaining on the silicon wafers cleaned using cleaning compositions prepared in either Example 2 or Example 5, each of which had a pH of about 5.0, were generally less than the amounts remaining on the silicon wafer cleaned using the cleaning composition prepared in Example 1, which had a pH of about 10.5. Thus, the ability to prevent metallic contamination may be controlled by adjusting the pH of the cleaning composition.

In accordance with exemplary embodiments of the present invention, the cleaning composition may remove polymer remaining on a substrate with reduced damage to a conductive structure formed on the substrate relative to a conventional cleaning composition, and may also reduce the amount that the conductive structure and the substrate are contaminated by particles and/or metallic impurities relative to a conventional cleaning composition. Thus, the number of defects formed in a semiconductor device may be reduced and the productivity of a semiconductor device manufacturing process may be increased.

Although exemplary embodiments of the present invention have been described, those skilled in the art will readily appreciate that many modifications may be made in the exemplary embodiments without materially departing from the scope of the present invention as defined by the accompanying claims.

What is claimed is:

1. A cleaning composition comprising:
about 80 to 99.8999 percent by weight of an ammonium fluoride aqueous solution;
about 0.1 to 5 percent by weight of a buffering agent; and,
about 0.0001 to 15 percent by weight of a corrosion-inhibiting agent.

2. The cleaning composition of claim 1, wherein the cleaning composition comprises:
about 93 to 99.4995 percent by weight of the ammonium fluoride aqueous solution;
about 0.5 to 3 percent by weight of the buffering agent; and,
about 0.0005 to 4 percent by weight of the corrosion-inhibiting agent.

3. The cleaning composition of claim 1, wherein the buffering agent comprises inorganic ammonium salt.

4. The cleaning composition of claim 3, wherein the inorganic ammonium salt comprises at least one selected from the group consisting of ammonium nitrate, ammonium sulfate, and ammonium iodate.

5. The cleaning composition of claim 1, wherein the corrosion-inhibiting agent comprises at least one selected from the group consisting of alkanesulfonic acid, carboxylic acid, alcohol, and a surfactant.

6. The cleaning composition of claim 5, wherein the alkanesulfonic acid comprises at least one selected from the group consisting of methanesulfonic acid, ethanesulfonic acid, propanesulfonic acid, and butanesulfonic acid.

7. The cleaning composition of claim 5, wherein the carboxylic acid comprises at least one selected from the group consisting of acetic acid, propionic acid, butyric acid, oxalic acid, malonic acid, maleic acid, succinic acid, glutaric acid, adipic acid, phthalic acid, and fumaric acid.

8. The cleaning composition of claim 5, wherein the alcohol comprises at least one selected from the group consisting of 1,4-buthanediol; 1,3-propanediol; 1,2-butanediol; 1,3-butanediol; 2,3-butanediol; and catechol.

9. The cleaning composition of claim 5, wherein the surfactant comprises a nonionic surfactant.

10. The cleaning composition of claim 1, wherein the ammonium fluoride aqueous solution comprises:
about 0.1 to 5 percent by weight of an alkylammonium hydroxide;
about 0.01 to 2 percent by weight of a fluorine-containing compound; and,
pure water.

11. The cleaning composition of claim 10, wherein the ammonium fluoride aqueous solution comprises:
about 0.2 to 3 percent by weight of the alkylammonium hydroxide;
about 0.05 to 1 percent by weight of the fluorine-containing compound; and,
pure water.

12. The cleaning composition of claim 10, wherein the alkylammonium hydroxide comprises at least one selected from the group consisting of tetramethylammonium hydroxide, tetraethylammonium hydroxide, tetrapropylammonium hydroxide, tetrabutylammonium hydroxide, tetrahexylammonium hydroxide, tetraoctylammonium hydroxide, benzyltriethylammonium hydroxide, diethyldimethylammonium hydroxide, hexadecyltrimethylammonium hydroxide, and methyltributylammonium hydroxide.

13. The cleaning composition of claim 10, wherein the fluorine-containing compound comprises at least one selected from the group consisting of hydrogen fluoride, ammonium fluoride, tetramethylammonium fluoride, tetraethylammonium fluoride, tetrapropylammonium fluoride, tetrabutylammonium fluoride, fluoroboric acid, tetramethylammonium tetrafluoroborate, tetraethylammonium tetrafluoroborate, tetrapropylammonium tetrafluoroborate, and tetrabutylammonium tetrafluoroborate.

14. The cleaning composition of claim 1, wherein the corrosion-inhibiting agent comprises about 0.1 to 5 percent by weight of a first corrosion-inhibiting agent and about 0.0001 to 10 percent by weight of a second corrosion-inhibiting agent.

15. The cleaning composition of claim 14, wherein the first corrosion-inhibiting agent comprises at least one selected from the group consisting of alkanesulfonic acid, carboxylic acid, and alcohol.

16. The cleaning composition of claim 14, wherein the second corrosion-inhibiting agent comprises a surfactant.

17. A cleaning composition comprising:
about 0.1 to 5 percent by weight of an alkylammonium hydroxide;
about 0.01 to 2 percent by weight of a fluorine-containing compound;
about 0.1 to 5 percent by weight of a buffering agent;
at least one corrosion-inhibiting agent; and,
pure water.

18. The cleaning composition of claim 17, wherein the at least one corrosion-inhibiting agent comprises about 0.1 to 5 percent by weight of at least one corrosion-inhibiting agent selected from the group consisting of alkanesulfonic acid, carboxylic acid, and alcohol.

19. The cleaning composition of claim 18, wherein the at least one corrosion-inhibiting agent further comprises about 0.0001 to 10 percent by weight of a surfactant.

20. The cleaning composition of claim 17, wherein the at least one corrosion-inhibiting agent comprises about 0.0001 to 10 percent by weight of a surfactant.

21. A method of preparing a cleaning composition comprising:
mixing about 0.1 to 5 percent by weight of an alkylammonium hydroxide, about 0.01 to 2 percent by weight of a fluorine-containing compound, and about 73 to 99.7899 percent by weight of pure water to prepare an ammonium fluoride aqueous solution; and,
adding about 0.1 to 5 percent by weight of a buffering agent and about 0.0001 to 15 percent by weight of a corrosion-inhibiting agent to about 80 to 99.8999 percent by weight of the ammonium fluoride aqueous solution.

22. A method of cleaning a substrate comprising:
preparing a cleaning composition comprising about 80 to 99.8999 percent by weight of an ammonium fluoride aqueous solution, about 0.1 to 5 percent by weight of a buffering agent, and about 0.0001 to 15 percent by weight of a corrosion-inhibiting agent; and
applying the cleaning composition to the substrate to remove polymer from the substrate, wherein a conductive structure is formed on the substrate and polymer is formed on the substrate, and to form a corrosion-inhibition layer on the conductive structure.

23. The method of claim 22, further comprising rinsing the substrate and drying the substrate.

24. The method of claim 22, wherein applying the cleaning composition is performed at a temperature of about 10° C. to 50° C.

25. The method of claim 22, wherein applying the cleaning composition is performed using a batch-type cleaning apparatus or a single-type cleaning apparatus.

26. The method of claim 22, wherein applying the cleaning composition is performed for about 5 to 20 minutes.

27. A method of manufacturing a semiconductor device comprising:
forming a conductive structure on a substrate; and,
cleaning the substrate using a cleaning composition comprising about 80 to 99.8999 percent by weight of an ammonium fluoride aqueous solution, about 0.1 to 5 percent by weight of a buffering agent, and about 0.0001 to 15 percent by weight of a corrosion-inhibiting agent.

28. The method of claim 27, wherein the conductive structure comprises a word line, a bit line, a pad, a plug, a contact, or a metal wiring.

29. The method of claim 27, wherein forming the conductive structure comprises:
successively forming an oxide layer, a conductive layer, and a mask layer on the substrate after forming an isolation layer in the substrate; and,
performing a dry-etching process to form an oxide layer pattern, a conductive layer pattern, and a mask pattern.

30. The method of claim 27, wherein forming the conductive structure comprises:
successively forming a conductive layer and a mask layer on the substrate after forming an insulation interlayer and a contact pad on the substrate; and,
performing a dry-etching process to form a conductive layer pattern and a mask pattern on the contact pad.

31. The method of claim 27, further comprising rinsing the substrate and drying the substrate.
